(19) United States
(12) Patent Application Publication
(10) Pub. No.: US 2026/0162149 A1
(43) Pub. Date: Jun. 11, 2026

(54) RETRIEVAL OF COMMERCIALS

(71) Applicant: Robert Newsteder, Sandown, NH (US)

(72) Inventor: Robert Newsteder, Sandown, NH (US)

(21) Appl. No.: 19/188,337

(22) Filed: Apr. 24, 2025

Related U.S. Application Data
(63) Continuation-in-part of application No. 18/969,494, filed on Dec. 5, 2024, now abandoned.

(51) Int. Cl. G06Q 30/0241; H04M 3/42

(52) U.S. Cl. CPC G06Q 30/0277; H04M 3/42365

(57) ABSTRACT

Playback of commercials, whether that of a broadcast of a radio commercial or a television commercial over the airwaves or via cable or via online apps, may be carried out by the user entering four digits online of the phone number of the sponsor of the commercial. A website catalogs the commercials in association with the sponsor's phone number and further information provided by the sponsor. If too many matches come up, inquiries may be made and responses compared with the further information for fewer matches. The further information may be products or services promoted in the commercial and date, place and time that the commercial was presented.

### CROSS-REFERENCE TO RELATED APPLICATIONS

This patent application is a continuation-in-part of patent application Ser. No. 18/969,494 filed Dec. 5, 2024.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE

Not applicable.

### BACKGROUND OF THE INVENTION

### 1. Field of the Invention

The present invention relates to retrieval of commercials, whether previously played as audio over a radio medium or played as video broadcast or over a network.

2. Description of Information Known to the Inventor, Including References to Specific Documents Related to the Invention, and Specific Problems Involved in the State of Technology that the Invention is Drawn Toward

U.S. Pat. No. 6,980,991B2 titled “Directory information system for providing toll free telephone numbers” is directed to an Internet-based directory information system for providing toll free telephone numbers and other company information based on product or service advertising. First and second web sites are configured with separate first and second graphic user interfaces for the entering of company information and search request information, respectively. A database correlates entered company information (including toll free telephone number) to advertising information, compares the company-provided advertising information to a search request-provided advertising information, and formulates a search result based on matches between the search request and the company-provided advertising information.

U.S. Pat. No. 6,769,018B2 titled “System and method for providing easy access to the world wide web” is directed to a system for quickly and easily accessing preselected desired addresses or URLs on the Internet is disclosed in which a unique jump code for a particular desired address is published by printing it in an advertisement in a Yellow Pages directory or in a newspaper advertisement or by announcing it during a television or radio program. The user enters the jump code into an Internet location for receiving it, e.g., the home page of the Yellow Pages publisher, to access the desired address without typing the full URL. The user can then receive more information, promotional coupons, or the like. The system utilizes a published list of preselected Web sites that are each assigned a specific jump code (of four digits in one particular embodiment). A user desiring to access one of the preselected Web sites first gains access to the World Wide Web, using a Web browser, by accessing a special Web site which contains software for receiving any of the published four-digit jump codes and, based upon the stored relationship of the URLs corresponding to the input jump code, directly accesses the Web site corresponding to the jump code inputted by the user.

The descriptions of A-H below pertain to conventional tasks individually performed.
A, Automated dialers that track answered phone calls and send solicitations
B. Website storage of radio commercials
C. Uploading video to a website or via an app
D. Website storage of video for playback
E. Downloading video from a website or ia an app
F. Drop down windows of a website or via an app
G. Determination of the geographic location of a website visitor
H. Developing an Interactive App with Drop-Down Menu and Data Correlation
   A. Automated Dialers that Track Answered Phone Calls and Send Solicitation

Automated dialers are sophisticated software systems designed to streamline and enhance the process of making phone calls, particularly for businesses involved in telemarketing, customer service, and debt collection. These systems not only save time and resources but also ensure that agents are more productive by focusing only on answered calls. This document explores how automated dialers track answered phone calls and subsequently send solicitations to those numbers.

Tracking Answered Phone Calls: Automated dialers use various technologies and methodologies to track answered phone calls. Here are some key components involved in this process.

Caller Identification: Automated dialers are integrated with Caller ID systems that help identify the numbers being called. When a call is initiated, the dialer records the number and keeps track of the status of the call.

Call Detection Algorithms: Advanced call detection algorithms are employed to determine the outcome of each call. These algorithms can distinguish between different call statuses, such as answered calls, busy signals, voicemails, or unanswered calls. When a call is answered, the system registers this information in its database.

Real-time Monitoring: Automated dialers often include real-time monitoring capabilities, allowing administrators to oversee the progress of calls as they happen. This enables immediate identification and recording of answered calls.

Database Integration: The dialer's software is typically integrated with a customer relationship management (CRM) system or a similar database. Each answered call is logged into the system, capturing details such as the phone number, time of the call, and the agent (if applicable) who handled it.

Sending Solicitations to Answered Numbers: Once answered phone calls are tracked, the next step involves sending solicitations to those numbers. This process is automated and follows a systematic approach:

Segmenting Answered Numbers: The database of answered calls can be segmented based on various criteria, such as demographics, previous interactions, or buying behavior. This segmentation helps in creating targeted solicitation campaigns.

Automated Messaging: Automated dialers are equipped with messaging capabilities, allowing them to send pre-recorded messages or SMS to the answered numbers. These messages can be customized based on the segmentation to enhance relevance and effectiveness.

Follow-up Scheduling: For more personalized interactions, the system can schedule follow-up calls or messages. Agents or automated systems can be prompted to reach out to the answered numbers at specified times, ensuring timely and consistent communication.

Compliance and Opt-out Options: Automated dialers also incorporate compliance features to adhere to regulations such as the Telephone Consumer Protection Act (TCPA). They ensure that recipients who choose to opt-out or do-not-call lists are respected, thereby avoiding legal issues.

Automated dialers play a crucial role in modern telecommunication by efficiently tracking answered phone calls and sending solicitations to those numbers. Through the combination of advanced algorithms, real-time monitoring, and database integration, these systems enhance productivity and ensure targeted, compliant outreach. As technology continues to evolve, the capabilities of automated dialers are likely to become even more sophisticated, further optimizing the process of contact and solicitation.

### B. Website Storage of Radio Commercials

Efficient Storage and Management of Audio Content: In the digital age, websites serve as crucial platforms for hosting and managing a variety of media content, including radio commercials. Storing audio content effectively requires a blend of robust technical infrastructure, strategic organization, and user-friendly interfaces. This document outlines the steps and best practices for storing radio commercials on a website.

Choosing the Right Hosting Service: The first step in storing radio commercials on a website is selecting an appropriate hosting service. This service should offer ample storage space, high-speed data transfer, and reliable uptime to ensure seamless access to audio files. Cloud-based services such as AWS (Amazon Web Services), Google Cloud, and Microsoft Azure are popular choices due to their scalability and robust infrastructure.

### Considerations for Hosting Services

Storage Capacity: Ensure the hosting service provides sufficient storage to accommodate current and future audio files.
Bandwidth: High bandwidth is essential to handle multiple users accessing audio files simultaneously without lag.
Security: Look for features like encryption, DDoS protection, and regular backups to safeguard audio content.
Scalability: The hosting service should be able to scale up as the volume of audio content grows.

Organizing Audio Content: Organizing audio content is crucial for easy retrieval and management. Implement clear and intuitive naming conventions, metadata tagging, and a structured directory system.

Naming Conventions: Establish a consistent naming convention for all audio files. This could include the date, client name, and a brief description of the commercial. For example, “2025-02-14_ClientName_ProductAd.mp3” provides clear information at a glance.

Metadata Tagging: Metadata tagging enhances searchability and organization. Include tags such as the commercial title, length, genre, target audience, and keywords. This allows users to search for and filter audio files efficiently.

Directory Structure: Create a hierarchical directory structure to store audio files. Organize directories by client, campaign, or date, depending on what makes the most sense for your specific needs. For instance:
Client A
2025 Campaign
February
March

Uploading and Storing Audio Files: Develop a streamlined process for uploading and storing audio files on the website. This includes setting up an intuitive user interface for uploading, converting files if necessary, and ensuring files are correctly stored in the designated directories.

User-Friendly Upload Interface: Create an upload interface that allows users to easily drag and drop audio files. Include features such as progress bars, error messages for unsupported file types, and automated metadata tagging where possible.

File Conversion; Audio files come in various formats (e.g., MP 3, WAV, AAC). Ensure your system can convert different file types into a standard format if necessary to maintain consistency and accessibility.

Storing Files; Once uploaded, files should automatically be stored in the appropriate directory based on the predefined structure. Implementing scripts or automation tools can help manage this process efficiently.

Accessing and Playing Audio Files: Provide a seamless experience for users accessing and playing audio files. This involves setting up a media player on the website and ensuring files can be streamed or downloaded without issues.

Integrated Media Player: Integrate a reliable media player that supports various audio formats and offers essential controls such as play, pause, seek, and volume adjustment. Popular options include HTML5 audio players and third-party plugins like JW Player and Plyr.

Streaming and Download Options: Allow users to stream audio files directly from the website or download them for offline use. Ensure that streaming is smooth and uninterrupted by optimizing file sizes and leveraging content delivery networks (CDNs).

Ensuring Compliance and Rights Management: Managing radio commercials involves adhering to copyright laws and managing usage rights. Implement measures to ensure compliance and protect intellectual property.

Copyright Compliance: Ensure that all stored audio files have the necessary permissions and licenses. Keep records of licensing agreements and usage rights to avoid legal issues.

Digital Rights Management (DRM): Use DRM technologies to control how audio files are accessed and used. This can include limiting the number of downloads, preventing unauthorized sharing, and watermarking files to track usage.

Monitoring and Analytics: Track the performance and usage of stored audio files through monitoring and analytics tools. This helps in understanding user behavior, optimizing content, and making data-driven decisions.

Usage Analytics: Implement analytics tools to monitor how often audio files are played or downloaded, which files are most popular, and user demographics. This data can inform future content strategies and improve user engagement.

Performance Monitoring: Regularly monitor the website's performance to ensure audio files load quickly and playback is smooth. Use tools like Google Analytics, New Relic, or Datadog to identify and address any issues promptly.

Storing radio commercials on a website involves careful planning, robust infrastructure, and strategic organization. By choosing the right hosting service, organizing audio content effectively, providing seamless access, ensuring compliance, and leveraging analytics, websites can manage and showcase audio content efficiently while delivering a superior user experience.

### C. Uploading a Video to a Website or Via an App

Uploading a video to a website can be an essential task for various purposes, including sharing personal moments, educational content, marketing materials, or creative projects. This guide will walk you through the steps of uploading a video, ensuring it is optimized for web viewing, and managing it effectively.

Preparing Your Video: Before uploading your video, it is crucial to ensure that it is well-prepared and optimized for the web.

Video Format: The most common and widely accepted video formats for web upload are MP 4, MOV, and AVI. MP 4 is particularly favored for its balance between quality and file size.

Resolution and Aspect Ratio: Ensure that your video has a suitable resolution and aspect ratio. Common resolutions include 720p (1280×720), 1080p (1920×1080), and even 4K (3840×2160). The aspect ratio should typically be 16:9 for most platforms.

File Size: Consider compressing your video to reduce its file size without compromising too much on quality. Tools such as HandBrake or online services like Clipchamp can help with compression.

Editing: Edit your video to remove any unnecessary content, add transitions, adjust audio levels, and include captions or subtitles if needed. Software like Adobe Premiere Pro, Final Cut Pro, or free alternatives like DaVinci Resolve can be used.

Choosing the Right Platform: Different websites have different requirements and features for video uploads. Here are some popular platforms:

YouTube is the world's largest video-sharing platform, offering extensive features for upload, customization, and monetization.

Vimeo is known for higher quality video hosting and is popular among professionals and creatives.

Social Media Platforms like Facebook, Instagram, and Twitter also support video uploads, each with its own guidelines and best practices.

Uploading Your Video: The following steps outline the general process for uploading a video to most platforms:
Step 1: Log into your account on the chosen platform. If you do not have an account, you will need to create one.
Step 2: Navigate to the Upload Section: Most websites have a clearly marked “Upload” button or section. For example, on YouTube, you will find the upload icon at the top right corner of the page.
Step 3: Select Your Video File. Click the upload button and browse your computer to select the video file you wish to upload.
Step 4: Add Video Details. Fill in the necessary details for your video, such as the title, description, tags, and category. These details help in making your video discoverable.
Step 5: Choose Privacy Settings. Select the privacy settings for your video. Options usually include Public, Unlisted, and Private. Choose the one that best fits your needs.
Step 6: Upload and Process. Click the upload button to start the process. The platform will upload and process your video, which might take some time depending on the file size and your internet speed.

Post-Upload Management. After your video is uploaded, there are several steps you can take to ensure it reaches your intended audience and performs well.

Thumbnails: Create an eye-catching thumbnail that accurately represents your video. Thumbnails are often the first thing viewers see, so make sure it is engaging.

Annotations and End Screens: Add annotations or end screens to promote other content, encourage subscriptions, or provide additional information.

Sharing and Promotion: Share your video across social media platforms, embed it on your website, and use email marketing to reach a broader audience.

Uploading a video to a website involves several steps, from preparation and optimization to choosing the right platform and managing your content post-upload. By following these guidelines, you can ensure that your video is presented professionally and reaches the widest possible audience.

D. How to Choose from a Drop-Down Menu

Drop-down menus are a common user interface element in web and application design. They allow users to select one option from a list of choices. This guide will walk you through the steps on how to choose from a drop-down menu effectively.

Steps to Choose from a Drop-Down Menu

1. Identify the Drop-Down Men: First, locate the drop-down menu on the webpage or application. It typically appears as a clickable box with a downward-facing arrow next to it. The box may display a default option or a label indicating that you should make a selection.

2. Click on the Drop-Down Menu: Click the box or arrow to reveal the list of available options. The list will expand, displaying all the choices you can select from.

3. Scroll Through the Options: If the list of options is extensive, you may need to scroll up or down to view all the choices. Use your mouse wheel, touchpad, or the scroll bar to navigate through the list.

4. Select Your Desired Option: Once you have found the option you wish to choose, click on it. The selected option will now appear in the drop-down box, indicating that your choice has been made.

5. Verify Your Selection: Ensure that the correct option is displayed in the drop-down box. If you accidentally chose the wrong option, you can repeat the process to make a new selection.

Tips for Using Drop-Down Menus.
Be Patient: If the menu is slow to respond, give it a moment to load the options fully.
Use Keyboard Navigation: Some drop-down menus allow you to use the keyboard arrows to navigate through the options and the Enter key to select an option. This can be faster and more efficient.
Check for Sub-Menus: Some drop-down menus have nested sub-menus. Hover over or click on an option to see if additional choices appear.
Clear the Selection: If you need to clear your selection, look for a ‘Clear’ or ‘Reset’ button usually located near the drop-down menu.

Choosing from a drop-down menu is a straightforward process that involves identifying the menu, clicking to reveal options, scrolling if necessary, and selecting the desired option. With practice, you can navigate and make selections quickly and efficiently.

E. How to Download Files from a Website or Via an App

Downloading files from a website is a straightforward process that can be accomplished in a few simple steps. Follow this guide to ensure a smooth and efficient download experience.
Step 1: Access the Website. First, open your preferred web browser (such as Chrome, Firefox, Safari, or Edge) and navigate to the website from which you wish to download a file. You can do this by typing the website's URL directly into the address bar and pressing Enter.
Step 2: Locate the File. Once you are on the website, browse through the pages or use the search function to find the file you want to download. This could be a document, image, video, software, or any other type of file.
Step 3: Click the Download Link. When you have located the file, look for a download link or button. This is usually labeled with text such as “Download,” “Get File,” “Save,” or an icon resembling a downward arrow. Click on this link or button to initiate the download.
Step 4: Choose the Save Location: A dialog box will typically appear, prompting you to choose a location on your computer where you want to save the file. Select your desired folder or directory and click [0153] “Save” or “OK.”
Step 5: Monitor the Download. Your browser will begin downloading the file. You can usually monitor the progress in the download bar or section at the bottom of your browser window. Larger files may take longer to download, so be patient.
Step 6: Open the Downloaded File. Once the download is complete, you can open the file by navigating to the location where you saved it and double-clicking on it. Alternatively, you can access your downloaded files directly from your browser by opening the “Downloads” section, often found in the browser menu.

Troubleshooting Tips: If you encounter any issues while downloading a file, consider the following tips:
Ensure you have a stable internet connection.
Check that you have enough storage space on your device.
Verify that the website is reputable and that the file is safe to download.
Try using a different web browser or clearing your browser's cache and cookies.

By following these steps, you should be able to successfully download files from most websites.

### F. Determination of the Geographic Location of a Website Visitor

Determining the geographic location of visitors to a website is a crucial capability for a plethora of reasons, ranging from personalized user experiences to enhanced security measures. This document explores the various methods and technologies employed to ascertain the geographic location of a website visitor.

IP Address Geolocation: One of the most common methods for determining a visitor's geographic location is through their IP (Internet Protocol) address. Each device connected to the Internet has a unique IP address, which can be mapped to a general geographic area.

Geolocation Database, such as MaxMind's GeoIP, aggregate data from internet service providers (ISPs) and other sources to link IP addresses to physical locations. When a visitor accesses a website, the IP address is checked against the database, returning information such as the country, region, city, and sometimes the exact coordinates.

Accuracy and Limitations: While IP address geolocation is widely used, its accuracy can vary. At the country level, it is generally very accurate, but at the city or street level, it can be less reliable. Factors such as use of VPNs (Virtual Private Networks), proxies, and mobile networks can affect accuracy.

GPS and Mobile Data: For mobile users, geographic location can be determined more precisely using GPS (Global Positioning System) data. Modern smartphones are equipped with GPS receivers, which can provide accurate location data when permitted by the user.

Browser Geolocation API: Most modern web browsers support the Geolocation API, which allows websites to request a user's geographic location. When a user grants permission, the browser can use GPS, Wi-Fi, cell towers, and other sensors to determine the exact location and share it with the website.

Wi-Fi positioning systems (WPS) use the locations of nearby Wi-Fi networks to triangulate a device's position. This method is especially useful in urban areas with a high density of Wi-Fi networks.

How It Works. When a device connects to Wi-Fi, it can scan for other nearby networks. The unique identifiers (MAC addresses) of these networks are sent to a geolocation service, which has a database of Wi-Fi network locations. By comparing the detected networks with the database, the service can estimate the device's position.

Cell tower triangulation is another method used mainly for mobile devices. When a device connects to a cellular network, the service provider can estimate its location based on the signal strength and the distance from multiple cell towers.

Process: The device connects to multiple cell towers, and the time it takes for signals to travel to and from these towers is measured. By calculating the distance from at least three different towers, the device's approximate location can be triangulated.

HTML5 introduces a geolocation feature that enables websites to access the geographic location of a user. This method is a combination of GPS, Wi-Fi, and cell tower data and is facilitated through the user's browser.

Implementation: The website requests the location data through the browser's Geolocation API. If the user consents, the browser collects data from GPS, Wi-Fi, and cell towers to determine and share the location with the website. This method is highly accurate, especially for mobile devices.

Determining the geographic location of a website visitor can be achieved through various methods, each with its own advantages and limitations. IP address geolocation provides a broad location estimate, while GPS, Wi-Fi positioning, and cell tower triangulation offer more precise results. The choice of method depends on the required accuracy, the device used, and user consent.

By leveraging these technologies, websites can offer personalized content, improve user experience, enhance security, and better understand their audience's demographics.

G. Developing an Interactive App with Drop-Down Menu and Data Correlation

Creating an app that allows users to interact with a drop-down menu, input data, and correlate their selections with stored data can be a powerful and engaging tool. This guide will walk you through the process of developing such an app, from initial planning to final implementation.

Planning and Requirements; Before diving into development, outline the requirements and plan the app's functionalities. Key components of the app will include:
A user-friendly interface with a drop-down menu and input field
Backend storage for data
A search algorithm to correlate user input with stored data.
Mechanisms to display the results to the user

Choosing the Technology Stack: Selecting the right tools and technologies is essential for your app's success. Here are some recommended technologies:
Frontend: HTML, CSS, Javascript, and a framework/library like React or Vue.js
Backend: Node.js with Express, or Python with Flask/Django
Database: MongoDB, MySQL, or PostgreSQL

Designing the User Interface: A clean and intuitive user interface is key to user engagement. The main elements include:
Drop-Down Menu: A list of options for users to select from.
Input Field: Allows users to enter additional data.
Submit Button: Triggers the search and correlation process.

Implementing the Drop-Down Menu: Using HTML and JavaScript, one can create a drop-down menu like this:
Option 1
Option 2
Option 3

An input field can be created using a simple HTML form element. The backend development will handle storing data and correlating user inputs. Choose a database and set up the schema to store the data. For example, using MongoDB:

const mongoose = require(‘mongoose’);
const DataSchema = new mongoose.Schema({
option: String,
userInput: String,
correlatedData: String
});
const DataModel = mongoose.model(‘Data’, DataSchema);

Implement API endpoints to handle user inputs and search requests. Using Express.js:

const express = require(‘express');
const app = express( );
app.use(express.json( ));
app.post(‘/search’, async (req, res) => {
const { option, userInput } = req.body;
const result = await DataModel.findOne( { option, userInput });
res.send(result);
});
app.listen(3000, ( ) => console.log(‘Server running on port 3000’));

### Correlating Data

The core functionality of the app is to correlate user input with stored data. Implement a search algorithm that finds matches in the database based on the user's selections and input.

The search algorithm should efficiently find matches in the database. Here's a simple example:

const correlateData = async (option, userInput) => {
try {
const match = await DataModel.findOne( { option, userInput });
return match ? match.correlatedData : ‘No match found’;
} catch (error) {
console.error(‘Error finding match:’, error);
return ‘Error occurred’;
}
};

Displaying Results. Once the backend has processed the user input and found a match, the results should be displayed to the user.

Updating the Frontend. After receiving the response from the backend, update the UI to show the correlated data:

document.getElementById(‘submitBtn’).addEventListener(‘click’, async ( ) => {
const option = document.getElementById(‘dropdown’).value;
const userInput = document.getElementById(‘userInput’).value;
const response = await fetch(‘/search’, {
method: ‘POST’,
headers: { ‘Content-Type’: ‘application/json’ },
body: JSON.stringify( { option, userInput })
});
const result = await response.json( );
document.getElementById(‘result’).innerText = result.correlatedData || result;
});

Developing an app that allows users to make selections from a drop-down menu, enter input, and correlate this with stored data involves several key steps. From planning and designing the user interface to implementing the backend and search algorithms, each component plays a critical role in ensuring a seamless user experience. By following this guide, you can create an efficient and user-friendly app that meets your requirements.

At the RadioDiscussions post at radiodiscussions.com/threads/announcing-phone-numbers-on-radio-commercials.565315 can be found the following sampling of discussions from 2009:
Why is it that announcers insist on repeating phone numbers on radio commercials four, five, six times in the course of 60 seconds? I heard one the other day for a credit repair company that announced the phone number SEVEN TIMES in less than 25 seconds!! Do they think people are that stupid that they can't remember a phone number if repeated twice, maybe three times? Nothing makes me reach for the button faster whenever I hear one of those hucksters start their spiel!
The bottom line answer to the question you underlined is: They know people won't remember the number with one or two mentions.
Pretend you're interested in one of these companies- and see if you can remember the number. The majority of folks can't. The frantic pace of life has contributed to this. The lack of creativity has as well.
I've always thought, unless you had a very easy-to-remember number (or pseudo number), it made much more sense to repeat the name of your business so interested listeners could look up the number later.
Endlessly repeating a phone number irritates most people and I would think that is the last thing an advertiser wants to do.
I hear: 60s with the number mentioned twice in the middle of the ad, and repeated twice at the end. That at least seems more reasonable to me. 7 seems excessive!
I think we are all dodging around an inconvenient fact in this discussion. I think MOST of the commercials that beat the phone number to death are some kind of direct-sale of something, though some brick and mortar stores have overused the phone number.
The station is often being paid on PER INQUIRY. The station gets paid IF you pick up the phone and call now. If you look them up on the Internet or drive over to the store and make a purchase, that station doesn't get paid. And possibly there is a phone-bank contractor involved, and if you don't pick up the phone and dial the number now, the contractor at the “boiler room” makes no income.
There was a time in our industry that decent stations looked down their nose with a lot of contempt at Per Inquiry ads and contempt for stations to accepted them.
Welcome to 2009.

It is now 2024 and too much time has elapsed to continue to give advertisers little choice but to repeat phone numbers multiple times in an effort to have listeners remember the phone number later when the listener has the time to act on it. It would therefore be desirable to provide an alternative in which the advertiser merely needs to mention a website that listeners either are already familiar with or can easily remember and to instruct them to type in four digits of the phone number only rather than all seven digits or more.

Advertisers spend a considerable amount of money having a commercial created for presentation on the radio or television or other broadcast medium. Each time the commercial is broadcast, the advertiser pays a fee to the station airing the broadcast. Thus, the advertising budget is substantial. However, listeners to the commercial may not recall the phone number mentioned in the commercial to use it when they are able. Further, they may recall the commercial, but not have a need for the service or product until much later and might only have recalled the last four digits of the phone number, which might have been easier to recall if they were part of a jingle or an alphanumeric pattern or a word, even if the word has more than four letters.

It would therefore be desirable to create a website that allows advertisers to keep their commercials accessible for playback to consumers for a relatively nominal fee considering the amount of expenditure incurred in creating and broadcasting the commercials. Such a website preferably provides the commercial for playback based on the consumer entering either the four digits of the phone number they recalled or an alphanumeric pattern (e.g., A+B+C+D+E+F+G) that was advertised for the phone number or a word advertised for the phone number (such as PAVING), even if there are more than four alphanumeric characters.

It would be desirable to retrieve a commercial for a consumer who previously was presented with that commercial, but remembers little or nothing about the sponsor other than four digits of a phone number associated with the sponsor of the commercial as well as the content of the commercial and the medium on which the commercial was presented.

### SUMMARY OF THE INVENTION

One aspect of the invention resides in a system that allows sponsors of commercial advertisements to upload them to a website that plays them back to users of the website who enter four digits or alphanumeric characters indicative of the sponsor's phone number as advertised in the commercial and, if need be, information pertaining to the advertised product or service as best understood from the commercial advertisement that was previously presented to the user, such as over a radio or broadcast medium. The user may also be asked to provide the approximate place, date and time that the commercial advertisement was presented. The commercial advertisement may be in the form of an audio radio or phone commercial or a video broadcast or network commercial.

Another aspect resides in the invention taking steps to minimize the time that the user spends entering information by using drop down windows or the like that the user may choose from to answer inquiries. For instance, if the geographical location where the commercial was presented to the user is needed to help identify the appropriate commercial that the user saw, then the invention may ascertain the approximate geographical location of the device the user is using to enter information into the interface with the invention and thus present a drop down window that identifies that geographic location and asks the user to confirm whether that geographical location is or is close to where the commercial has been presented.

The present inventor desires to expand upon his invention set forth in U.S. Pat. No. 7,340,468 B1 by having the determination for providing company information be based upon entry of a four-digit number recalled by a consumer, perhaps as part of a company phone number he or she heard such as from a radio commercial or saw on a television commercial and who desires to contact the company. What is needed is retrieval the commercial for playback to the user.

### BRIEF DESCRIPTION OF THE DRAWING

For a better understanding of the present invention, reference is made to the following description and accompanying drawings, while the scope of the invention is set forth in the appended claims.

FIGS. 1A and 1B together constitute a flow chart diagram of an apparatus that performs steps to store and retrieve commercials for playback in accordance with the invention.

### DETAILED DESCRIPTION OF THE INVENTION

The contents of U.S. Pat. No. 7,340,468 B1 is incorporated herein in its entirety.

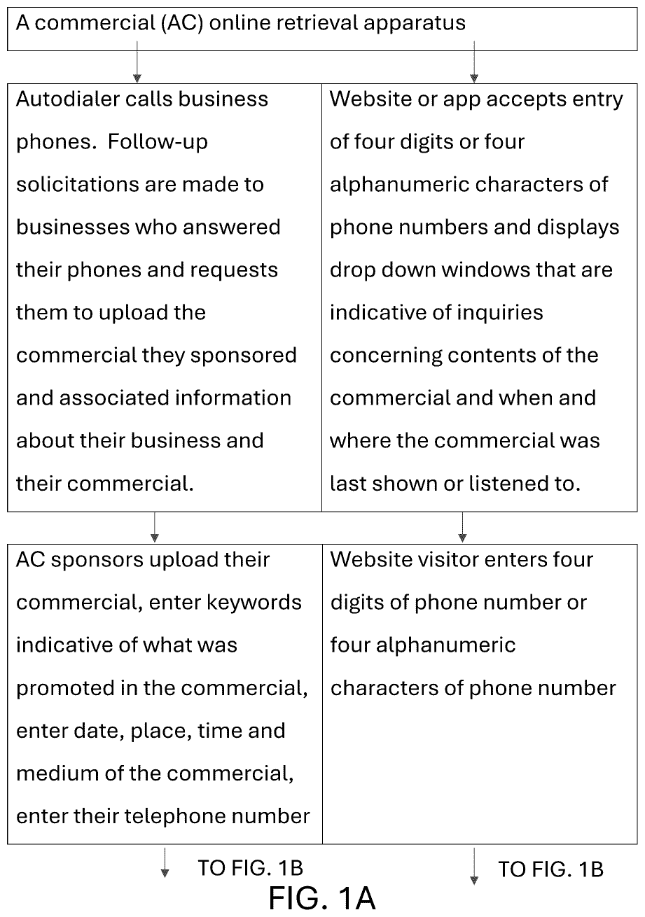

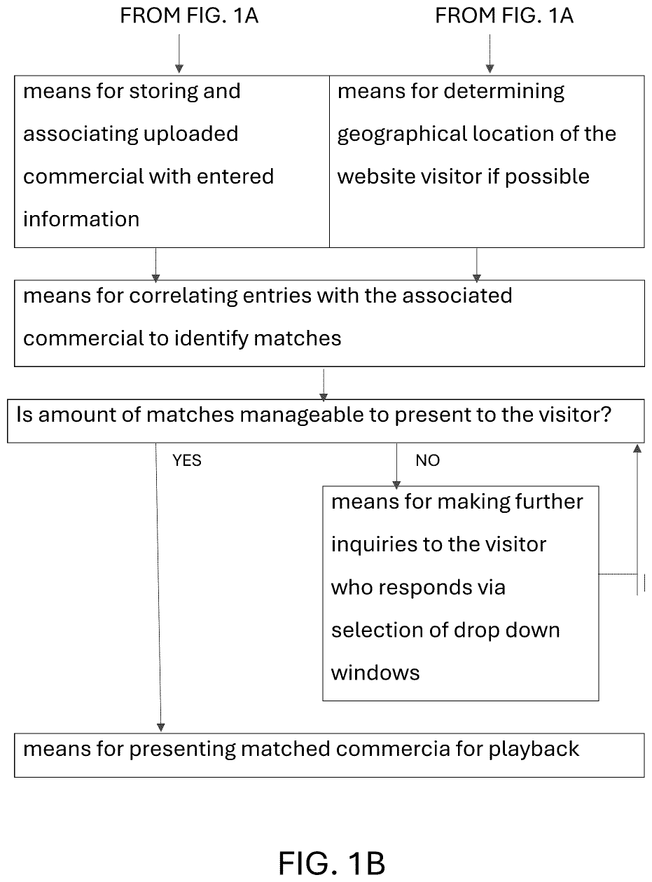

FIGS. 1A and 1B show modules and tasks that affect sponsors of commercials on the left and show modules and tasks that affect website visitors or app users on the right. Potential businesses whose phone numbers are active are identified and solicited to sign up to enable their commercials to be available for access and play back by consumers, who may recall something about the sponsor's commercial that they recall. Such consumers may not have recalled enough information to contact the sponsor without viewing the commercial again.

The sponsor uploads the commercials and provides keywords about what was promoted in the commercials, such as the generic names of products or services, and information as which medium the commercials was presented (e.g., radio, television, cable, an Internet programming app, etc.) as well as the date, time and place where the commercials were previously presented. The sponsor also provides its business phone number that was presented in the commercial, although such could instead by searched by software and then presented to the sponsor to confirm its accuracy. Commercials are a form of advertisement that is broadcast over the radio airwaves or television airwaves or shown via cable or programming apps that provide any type of streaming media content delivered over the Internet.

The website visitor or app user is asked online or through an app to enter four digits or four alphanumeric characters of the business phone number they recall from the commercial. A search is conducted through a database containing the stored information from the sponsors to find a match. If there is only a manageable few that are matched, then they are all presented to the website visitor or app user together with the associated keywords. The visitor or app user is asked to choose which commercial associated with the keywords that the visitor or app user wants to play back.

To carry these steps out, a correlation means, which may be software driven, is provided for making a correlation of uploaded commercials with contact information pertaining to sponsors of the commercials and with further information pertaining to content of the commercials and to medium presentation history of the commercials, wherein the contact information includes digits or alphanumeric characters associated with telephone numbers of the sponsors. Further, a retrieval means, which may also be software driven, is provided that is responsive to entries (either online or via an app) to find matches between the entries and the contact information and the further information for carrying out retrieval of the uploaded commercials associated with the matches for playback. The entries include four digits or four alphanumeric characters that correspond with four digits or four alphanumeric characters of a phone number of one of the sponsors of the commercials in the contact information.

For example, the website visitor or app user enters four digits of the business phone number that the visitor recalls. A search is conducted and identified a number of matches. If that number does not exceed a manageable number, the results from the search are all presented and the website visitor or app user is asked to choose which one to playback. The manageable number is somewhat arbitrary but would likely be ten or less. The purpose is to lessen the amount of effort the website visitor or app user has to spend to find the commercial of interest for playback.

For that reason, when the results from the search exceed the manageable number. a further inquiry is made of the visitor or app user to identify what was promoted in the commercial. For this example, the user enters “insurance”. A follow-up search is conducted, but assume the number of matches still exceeds the manageable number. If so, then a further inquiry can be made as to the nature of the insurance, i.e., life, health, property, automobile, etc. Once that information is entered by the visitor, a narrower search is conducted. If a manageable number of matches are found, they are presented to the visitor to choose. Otherwise, further inquiries are made, such as to seeking to identify the medium over which the commercial was presented and its approximate date and time that the commercial was presented.

In addition, the geographical location of the visitor entering the information or using the app might be detectable with appropriate tracking software of the device so that the website visitor or app user merely needs to be asked whether that geographical location that was found was approximately where the commercial was presented. If such is not the location where the commercial was presented as far as the website visitor or app user can recall, then the website visitor or app user is asked to enter the geographical location. A narrower search is conducted based on all this additional information and the results are presented for the visitor to make a selection. Chances are the number of matches is a manageable number.

As should be understood from the foregoing, the present invention is directed to an apparatus and method that retrieves commercials. Correlation means are provided for making a correlation of uploaded commercials with contact information pertaining to sponsors of the commercials and with further information pertaining to content of the commercials and to medium presentation history of the commercials. The contact information includes digits or alphanumeric characters associated with telephone numbers of the sponsors. Further, retrieval means are provided that is responsive to entries to find matches between the entries and the contact information and the further information for carrying out retrieval of the uploaded commercials associated with the matches for playback. The entries include four digits or four alphanumeric characters that correspond with four digits or four alphanumeric characters of a phone number of one of the sponsors of the commercials in the contact information.

The playback may be at the website via a video/audio player or via an app equipped with the same. An app is a self-contained software package that allows users to perform specific tasks on a mobile or desktop device. Drop-down windows may be provided that have words that describe what was presented in the commercials. In that way, the words in the drop-down windows constitute some of the entries that undergo the correlation upon selection of them from the drop-down menu.

Means are provided for obtaining geographical information as to a location of a device that provides the entry of the digits and for making an inquiry as to whether the geographical information reflects where the commercial was presented and, if confirmed, including the geographical information as part of the entries that undergo the correlation.

A conventional autodialer is provided as a means for autodialing business phone numbers and sending solicitations to sponsors associated with the business phone numbers that were answered from the autodialing, wherein the contact information includes the business telephone numbers of at least some of the sponsors who responded to the sent solicitations. The solicitations may be in the form of text messages. Otherwise, the business phone numbers that were answered is provided for subsequent callback by a human being who makes the solicitation or request permission from the business owner to have artificial intelligence call back, which would announce at the beginning of the call that it was artificial intelligence.

While the foregoing description and drawings represent the preferred embodiments of the present invention, various changes and modifications may be made without departing from the scope of the present invention. To implement the preferred embodiments, conventional tasks are used that are known individually as previously mentioned in the description of the Background of the Invention. That Is:
A, Automated dialers that track answered phone calls and send solicitations
B. Website storage of radio commercials
C. Uploading video to a website or via an app
D. Website storage of video for playback
E. Downloading video from a website or via an app
F. Drop down windows of a website or via an app
G. Determination of the geographic location of a website visitor
H. Developing an Interactive App with Drop-Down Menu and Data Correlation

1. The apparatus of claim 15, wherein the database has stored information that includes contact information pertaining to sponsors of the uploaded commercials, content information pertaining to content of the uploaded ones of the commercials and medium presentation information pertaining to a history of medium presentation of the uploaded ones of the commercials, wherein both the uploaded ones of the commercials and the contact information include seven or more digits or alphanumeric characters associated with telephone numbers of the sponsors of the uploaded commercials.

2.-3. (canceled)

4. The apparatus of claim 1, wherein the website or the mobile app has means for obtaining geographical information as to a location of a device that provides the entry and for making an inquiry concerning the geographical information.

5.-7. (canceled)

8. The method of claim 17, wherein the database has stored information that includes contact information pertaining to sponsors of the uploaded commercials, content information pertaining to content of the uploaded commercials and medium presentation information pertaining to a history of medium presentation of the uploaded commercials, wherein both the uploaded commercials and the contact information include seven or more digits or alphanumeric characters associated with telephone numbers of the sponsors of the uploaded commercials.

9.-10. (canceled)

11. The method of claim 8, wherein the website or mobile app obtains geographical information as to a location of a device that provides the entry and for making an inquiry concerning the geographical information.

12.-14. (canceled)

15. An apparatus for retrieval of commercials, comprising:
a database that stores telephone numbers in correlation with uploaded ones of commercials, wherein the stored telephone numbers include telephone numbers presented in the uploaded ones of the commercials upon playback of the uploaded ones of the commercials;
a website or mobile app configured to search through the database in response to an entry of either four, and only four, digits or four, and only four, alphanumeric characters to find matches between the entry and the stored telephone numbers; and
a video player or audio player at the website or app that is configured to perform playback of the uploaded ones of the commercials from the matches and thus present the telephone numbers during the playback.

16. The apparatus of claim 15, wherein the website or the mobile app is configured for making a determination as to whether presenting all of the uploaded ones of the commercials for playback that correspond with the found matches would be manageable and, if so, presenting the uploaded ones of the commercials but, if not, making further inquiries pertaining to a viewed or listened to one of the uploaded ones of the commercials.

17. A method for retrieval of commercials, comprising:
storing telephone numbers in a database in correlation with uploaded ones of commercials, wherein the stored telephone numbers include telephone numbers presented in the uploaded ones of the commercials upon playback of the uploaded ones of the commercials;
searching, via a website or mobile app, through the database in response to an entry of either four, and only four, digits or four, and only four, alphanumeric characters to find matches between the entry and the stored telephone numbers; and
performing the playback, via a video player or audio player at the website or app, of the uploaded ones of the commercials from the matches and thus present the telephone numbers during the playback.

18. The method of claim 17, wherein the website or mobile app makes a determination as to whether presenting the uploaded ones of the commercials that correspond with the found matches for playback would be manageable and, if so, presenting the uploaded ones of the commercials that correspond with the found matches but, if not, making further inquiries pertaining to a viewed or listened to one of the commercials.

19. The apparatus of claim 16, wherein the website or mobile app has drop down windows that display the further inquiries.

20. The method of claim 18, wherein the website or mobile app display the further inquiries in drop down windows.
